(19) United States
(12) Patent Application Publication
(10) Pub. No.: US 2023/0058359 A1
(43) Pub. Date: Feb. 23, 2023

(54) FILM AND SEED COATING COMPOSITION

(71) Applicant: Croda International Plc, Goole, East Yorkshire (GB)

(72) Inventors: Dirk Klomp, Goole, East Yorkshire (GB); Jerome Sylvain Garnier, Goole, East Yorkshire (GB); Pieter Wilhelmus Johannes Samuels, Goole, East Yorkshire (GB)

(73) Assignee: Croda International Plc, Goole, East Yorkshire (GB)

(21) Appl. No.: 17/792,551

(22) PCT Filed: Jan. 15, 2021
(86) PCT No.: PCT/EP2021/050822

§ 371 Date: Jul. 13, 2022

(30) Foreign Application Priority Data
Jan. 16, 2020 (GB) 2000685.4

(51) Int. Cl. C09D 193/04; C09D 191/06; A01C 1/06

(52) U.S. Cl. CPC C09D 193/04; A01C 1/06; C09D 191/06

(57) ABSTRACT

A film coating composition, and seed coating composition formed comprising the film forming composition. The film coating composition comprises rosin resin and/or starch derivative and wax dispersion. The sum of rosin/starch and wax in the film coating composition being in the range 2 to 60 wt.%. The seed coating formulation optionally comprises an agrochemical active and/or nutrient, and is applied to seeds or bulbs for wet and dry flowability, abrasion resistance, dust off, germination, plantability and colour retention. In particular, the seed coating composition provides said properties whilst essentially or completely microplastic free. There is also provided a method of making the formulations, and for treating seeds or bulbs with seed coating formulation.

The present invention relates to a film and seed coating composition, to a method of forming a film and seed coating composition and coating on to a seed or bulb, and to a coated seed or bulb, for use in coating seeds or bulbs.

Plant seed are often coated before sowing, for example, to protect seeds from damage during handling and/or to improve handling properties. Seeds are often coated to provide useful substances (active ingredients) to the seed and the seedlings upon germination, for example, plant nutrients, growth stimulating agents, and plant protective products. Many existing seed coatings have the disadvantage of also including components which are not desirable, for example microplastics.

The present invention seeks to provide a film and seed coating composition, where the composition provides desired wet flowability, abrasion resistance, dust off, germination, and plantability to a seed coated with said formulation and to a plant formed from a coated seed. Preferably, providing the required physical properties whilst also being essentially or completely microplastic free

According to a first aspect of the present invention there is provided a film coating composition comprising
i) rosin resin and/or starch derivative; and
ii) wax dispersion;
wherein the sum amount of said rosin resin and/or starch derivative and wax dispersion is in the range from 2 wt.% to 60 wt.% based on the total weight of the composition.

According to a second aspect of the present invention there is provided a method of forming a film coating composition which comprises combining
i) rosin resin and/or starch derivative; and
ii) wax dispersion;
wherein the sum amount of said rosin resin and/or starch derivative and wax dispersion is in the range from 2 wt.% to 60 wt.% based on the total weight of the composition.

According to a third aspect of the present invention there is provided a method of coating seed or bulbs which comprises applying a seed coating composition which comprises a film coating composition in accordance with the first aspect, to said seed or bulb.

According to a fourth aspect of the invention, there is provided a seed or bulb with a seed coating, said seed coating composition comprising a film coating composition in accordance with the first aspect.

The film coating composition of the present invention may be used to improve the seed or bulbs physical qualities, especially wet and dry flowability, abrasion resistance, dust off, germination, plantability and colour retention. In particular the seed coating composition allows for seed coatings which can provide the required physical properties whilst also being essentially or completely microplastic free.

As used herein, the terms "for example", “for instance", "such as", or "including" are meant to introduce examples that further clarify more general subject matter. Unless otherwise specified, these examples are provided only as an aid for understanding the applications illustrated in the present disclosure, and are not meant to be limiting in any fashion.

The term “seed” as used in this application is meant to refer in particular to the ripened ovule of gymnosperms and angiosperms, which contain an embryo surrounded by a protective cover. The protective cover can comprise the seed coat (testa). Some seeds comprise a pericarp or fruit coat around the seed coat. In particular, when this layer is closely adhered to the seed, as in cereal kernels, it is in some cases referred to as a caryopsis or an achene. As used in this application, the term “seed coat” is meant to include a caryopsis or an achene. The term “seed” includes anything that can be planted in agriculture to produce plants, including pelleted seeds, true seeds, plant seedlings, rootstock, regenerable and plant forming tissue, and tubers or bulbs.

The term “coating” as used in this application, is meant to refer to applying material to a surface of a seed, for instance as a layer of a material around a seed. Coating includes film coating, pelleting, and encrusting or a combination of these techniques as known in the art. It will be understood that the term “film coating” refers to a concentrated composition which can be diluted and formed in to a slurry with other components added, such as agrochemical actives, in order to make a “seed coating” which is then applied to the seeds or bulbs. The term “seed coating composition” as used in this application is meant to refer to a composition to be used for coating of seed.

The coating is preferably applied over substantially the entire surface of the seed, such as over 90% or more of the surface area of the seed, to form a layer. However, the coating may be complete or partial, for instance over 20% or more of the surface area of the seed, or 50% or more.

The seed is a plant seed, for example a seed of an agricultural or field crop, a vegetable seed, a herb seed, a wildflower seed, an ornamental seed, a grass seed, a tree seed, or a bush seed.

Preferably, the plant seed is of an agricultural crop. The seed may be of the order of Monocotyledoneae or of the order of Dicotyledoneae. Suitable seeds include field crop seeds like soybean, cotton, maize, cereals including but not limited to wheat, barley, oat and rye, oil seed rape (or canola) sunflower, sugar beet, flax, rapeseed, tobacco, hemp seed, alfalfa, signal grass, sorghum, chick pea, beans, peas, rice, and sugar cane. Examples of suitable vegetable seeds include asparagus, chives, celery, leek, garlic, beetroot, spinach, beet, turnip, endive, chicory, parsley, fennel, radish, black salsify, eggplant, carrot, onion, tomato, pepper, lettuce, snap bean, shallot, safflower, chicory, and crops from the Brassicaceae or Cucurbitaceae families

Preferably, the plant seed is selected from crop seeds selected from the group consisting of corn, sunflower, soybean, cotton, rice, and spinach.

Preferably, the plant seed is capable of germinating. Optionally, the seed may be deprived of husk (so called husked seed or de hulled seed).

The term “flower bulbs” includes bulbs which grow in to bulbous plants and may include Alliums, Anemones, Crocus, Daffodils, Eranthis, Galanthus, Hyacinths, Iris, Lilies, Muscari, Scilla, and Tulips.

It is envisaged that the present invention may be used for seeds or flower bulbs, but may be particularly suitable for use with seeds.

A “rosin resin” or “rosin ester” according to the present invention is any molecule in which at least two rosin acid or rosin acid derivative units are connected by means of at least two ester linkages. Any molecule with at least two hydroxyl groups can be used to provide the ester linkage between at least two rosin acids units. Common examples include, but are not limited to, glycerol esters, pentaerythritol esters and (triethylene) glycol esters.

A “rosin acid” according to the present invention is understood to comprise a mixture of various rosin acid molecules. Mixtures of this kind that are readily available and occur in nature include, but are not limited to, tall oil rosin, gum rosin or wood rosin. These natural mixtures may comprise rosin acids of the abietic type and/or the pimaric type such as abietic acid, palustric acid, neoabietic acid, levopimaric acid, pimaric acid, isopimaric acid or dehydroabietic acid, among others, in varying amounts. In addition to rosin acids with one carboxylic acid functionality, rosin acids with two or more carboxylic acid functionalities are also considered as rosin acids in the meaning of the present invention.

A “rosin acid derivative” according to the present invention is any molecule that has the molecular rosin acid backbone but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

The “resin dispersions” according to the present invention are dispersions of rosin resin entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well.

Suitably, any rosin resin(s) or any rosin resinous material(s) conventionally used in resin dispersions are suitable for use according to the present invention. For example, suitable classes of resins include rosin esters, rosin resins, pentaerythritol, glycerol, triethylene glycol esters of rosin, or mixtures thereof.

Suitable rosin resins include, but are not limited to esters of natural and modified rosins and the hydrogenated derivatives thereof. Mixtures of two or more of the above-described resins suitably may be used in some embodiments.

Suitably, in other embodiments, the rosin can be an unmodified or a modified rosin. There are many different ways of modifying rosins. For example, the rosin can be esterified. In some embodiments, the rosin is a glycerol, pentaerythritol or triethylene glycol ester of a rosin acid. Suitably, in other embodiments, any low molecular weight compounds containing multiple hydroxyl groups could be used to produce rosin esters.

Rosin resins suitable for the aqueous resin dispersions of the invention include rosin acids and rosin derivatives. Rosin acids are produced from wood, gum or tall oil rosin. Wood rosin is harvested from the stumps of trees. Gum rosin is collected from the sap of trees in regions such as China and Brazil. Tall oil rosin is a by-product of the Kraft paper process. The distribution of rosin acid isomers varies within each of these sources. Rosin acids may be partially or fully hydrogenated or disproportionated.

Rosin derivatives may be dimerised or polymerised from rosin acid. Rosin derivatives also include rosin esters that are the reaction product of rosin acid and a single or multifunctional alcohol. Aromatic and aliphatic alcohols suitable for synthesising rosin esters include, but are not limited to, pentaerythritol, glycerol, triethylene glycol and methanol. Rosin derivatives may be modified with phenol, maleic acid, fumaric acid or other suitable polar compounds. Rosin acids may be partially or fully hydrogenated or disproportionated.

The rosin resin can be characterised by a Ring and Ball softening point ranging from about 10° C. to about 150° C. and have molecular weights from 300-10,000 g/mol. More preferably the resins range in softening point from about 10° C. to about 100° C. and have molecular weights from 300-3,000 g/mol.

Rosin resin dispersions suitable for this invention consist of waterborne dispersions of rosin resins containing 20 to 80% resin, preferably 30 to 70% resin and more preferably 40 to 60% resin.

The composition may comprise starch derivatives as an alternative or in addition to rosins. The starch derivatives of the present invention in particular refer to starches and related polymeric carbohydrates.

Examples thereof include starches, and dextrins (including cyclodextrins), and maltodextrins.

The starch may be derived from a plant source including corn/maize, rice, tapioca, and potato. Derivatives of starch obtained from these plant sources that are modified through chemical/physical processes including but not limited to hydrolysis, esterification, etherification, crosslinking, grafting, oxidation and acetylation or a combination of these are also considered here. Also included are starches that are modified through breeding and genetics such as waxy maize starch, resistant starch and others.

The starch used as the basis of the invention may be derived from any native source. A native starch is one as it is found in nature. Also suitable are starches derived from a plant obtained by standard breeding techniques including crossbreeding, translocation, inversion, transformation or any other method of gene or chromosome engineering. In addition, starch derived from a plant grown from artificial mutations and variations of the above generic composition which may be produced by known standard methods of mutation breeding are also suitable.

Typical sources for the starches and flours are cereals, tubers, roots, legumes and fruits. The native source can be corn, pea, potato, sweet potato, banana, barley, wheat, rice, sago, amaranth, tapioca, arrowroot, canna, sorghum, and waxy or high amylose varieties thereof.

The wax may be selected from the group consisting of natural waxes, or mineral or synthetic wax when proved bio-degradable or non-polymeric. Preferably, the wax is selected from the group consisting of carnauba wax, bees wax, sunflower wax, soy oil wax, rice bran wax, lanolin wax, sugar cane wax, palm wax, or other vegetable waxes, poly(3-hydroxybutyrate-co-3-hydroxyvalerate) (PHBV) wax, calcium stearate, or polylactic acid (PLA) wax.

It is also possible that mixtures of two or more waxes are present in the film coating composition of the invention. In a preferred embodiment, the wax is selected from the group consisting of vegetable waxes. The waxes are used as dispersion or emulsion product of a wax which can be an anionic dispersion/emulsion, a non-ionic wax dispersion/emulsion or a cationic wax dispersion/emulsion. Most preferably, the wax can be anionic or non-ionic dispersion/emulsion form. Cationic wax dispersions/emulsions may give rise to flocculation problems when the film coating composition is combined with anionically stabilised active ingredients.

The film coating composition and/or the seed coating composition may also include other components as desired. These other components may be selected from those including:
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
antifoam agents, e.g. polysiloxane antifoam agents, typically in amounts of 0.005 wt.% to 10 wt.% of the formulation;
viscosity modifiers such as commercially available water soluble or miscible gums, e.g. xanthan gums, and/or cellulosics, e.g. carboxy- methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt.% to 1 wt.% of the formulation.
pigment concentrates, effect and pearlescent pigments.

The amount of water in the seed coating composition is suitably less than 85%, preferably less than 80%, more preferably less than 75%, particularly in the range from 35 to 70%, and especially 45 to 65% by weight based on the total weight of the composition.

The film and/or seed coating composition of the present invention may also contain one or more optional pigments, which function to provide an aesthetic effect when coated on seed. The pigment is preferably an inorganic material and may, for example, be an effect pigment and/or a coloured pigment as known in the art.

Examples of suitable effect pigments include pearlescent pigment in different particle sizes. Effect pigments having a particle size of 60 µm or less, or a particle size of 15 µm or less may be used. The particle size of the effect pigment is preferably not more than 200 µm, more preferably not more than 100 µm. Usually, the particle size of the effect pigment is 1 µm or more. Another effect pigment can be aluminium. Effect pigments can be used to create an attractive cosmetic look on the seeds.

Examples of coloured pigments include pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793 37 8), and pigment white 6 (CAS No. 98084-96-9). The particle size of the coloured pigment is preferably not more than 100 µm, more preferably not more than 50 µm. Usually, the particle size of the coloured pigment is 25 µm or more.

A dye such as anthraquinone, triphenylmethane, phthalocyanine, derivatives thereof, and diazonium salts, may be used in addition to or as an alternative to a coloured pigment.

The amount of pigment in the film and/or seed coating composition, if present, is suitably in the range from 0.1to 15%, preferably 1.0 to 8.0%, more preferably 2.0 to 5.0%, particularly 2.5 to 3.5%, and especially 2.8 to 3.2% by weight based on the total weight of the composition.

The seed coating composition of the invention may also comprise a surface active agent such as a wetting, dispersing and/or emulsifying agent. The surface active agent may aid in mixing/emulsifying/ dispersing the wax and/or pigment particles in the pre-blend and seed coating composition.

The seed coating composition of the invention may comprise further components such as one or more selected from a solvent, a thickener, an anti-foaming agent, a preservative, and a slip additive.

Suitable thickeners include agar, carboxy methylcellulose, carrageenan, chitin, fucoidan, ghatti, gum arabic, karaya, laminaran, locust bean gum, pectin, alginate, guar gum, xanthan gum, diutan gum, and tragacanth, bentonite clays, HEUR (hydrophobically modified, ethoxylated urethane) thickeners, HASE (hydrophobically modified, alkali-swellable emulsion) thickeners and polyacrylates. Gums are generally preferred because of their low cost, availability and superior ability to enhance the physical characteristics of the resultant coated film.

Examples of suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyl modified polysiloxanes, polyether siloxane copolymer containing fumed silica. The antifoaming agent may be present in some embodiments of the seed coating composition in an amount of at least 1 ppm by weight, or 0.1 to 0.3% by weight based on the total weight of the seed coating composition.

The seed coating composition further may comprise one or more solvents other than water. Solvents may be selected from the group consisting of alcohols, and hydrocarbons. Also mixtures of solvents can be used. It is preferred that the solvent is liquid at 20° C. and 1 atm. Examples of suitable solvents include glycols and their esters and ethers, in particular ethylene and propylene glycols and their esters and ethers, for instance, esters and ethers with C1 C6 alkyl groups and/or aromatic groups, such as methyl, ethyl, propyl, butyl, benzyl and phenyl ethers, including mono ethers and dialkyl ethers, and esters of these ethers, such as acetates, and ethylene and propylene glycol esters, for instance of fatty acids; polyethylene glycol (PEG) and polypropylene glycol and esters thereof, especially with fatty acids; butyl cellosolve, butyl carbitol, polyethylene glycol; N methylpyrrolidone, glycerine, alkyl alcohols with up to 10 carbon atoms, such as ethanol, propanol and butanol. Other examples of solvents include dipropylene glycol methyl ether and propylene glycol methyl ether. An important solvent is ethylene glycol. Further examples include propylene tetramer and synthetic ester oils such as lactate esters, particularly ethyl lactate and benzoate esters e.g. iso-propyl or 2-ethylhexyl benzoates. Aromatic hydrocarbons such as xylene, aliphatic and paraffinic solvents and vegetable oils can also be used as solvent. Aromatic solvents are less preferred.

The seed coating composition may also comprise components with a plasticising effect, such as surfactants or antifreeze agents. Common surfactants include amphiphilic organic compounds, usually comprising a branched, linear or aromatic hydrocarbon, fluorocarbon or siloxane chain as tail and a hydrophilic group. Some types of surfactants include non-ionic, anionic, cationic and amphoteric surfactants, and organosilicone and organofluorine surfactants. Some examples of surfactants include polyoxyethylene glycol and polyoxypropylene ethers and esters, in particular alkyl, aryl and alkylaryl ethers thereof, and sulphates, phosphates and sulphonic acid compounds of such ethers, glucoside (alkyl) ethers, glycerol esters, such as alkyl and fatty acid esters, sorbitan (alkyl) esters, acetylene compounds, cocamide compounds, block copolymers of polyethylene glycol and propylene glycol. Further examples of surfactants include alkylamine salts and alkyl quaternary ammonium salts, for example betaine type surfactants, amino acid type surfactants; and polyhedric alcohols, fatty acid esters, in particular C12 C18 fatty acids, for instance of polyglycerin, pentaerythritol, sorbitol, sorbitan, and sucrose, polyhydric alcohol alkyl ethers, fatty acid alkanol amides, and propoxylated and ethoxylated compounds such as fatty alcohol ethoxylates, polyethyxlated tallow amine and alkylphenol ethoxylates. Some examples of anionic surfactants include carboxylic acids, copolymers of carboxylic acids, sulphates, sulphonic acid compounds and phosphates, for example lignin sulphonates and (linear) alkylaryl sulphonates.

Anti-freeze agents include for example: ethylene glycol, propylene glycol, 1,3 butylene glycol, hexylene glycol, diethylene glycol, and glycerin, with the preferred glycol being ethylene glycol and propylene glycol.

A biocide can be included in some embodiments of the seed coating composition for instance as preservative, in order to prolong the shelf life of the seed coating composition before being applied to a seed, such as when being stored. Examples of suitable biocides include MIT (2 methyl 4-isothiazolin-3-one; CAS No. 2682 20-4), BIT (1,2 benzisothiazolin-3-one; CAS No. 2632-33-5) ), CIT (5-Chloro-2-methyl-4-isothiazolin-3-one), Bronopol (2-Bromo-2-nitro-propane-1,3-diol ) and/or a combination of these.

The seed coating composition may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides. Further possible active ingredients include disinfectants, micro organisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

The amount of active ingredient applied, of course, strongly depends on the type of active ingredient and the type of seed used. Usually, however, the amount of one or more active ingredients is in the range of 0.001 to 200 g per kg of the seed. The skilled person is able to determine suitable amounts of active ingredient depending on the active ingredient and the type of seed used. It is common practice for the skilled person to use and follow the advice of the active ingredient suppliers (e.g., BASF, Bayer, Syngenta, Corteva, etc.), such as by using technical data sheets and/or following recommendations.

Typical fungicidal agents include Captan (N trichloromethyl)thio 4 cyclohexane 1,2-dicarboximide), Thiram tetramethylthioperoxydicarbonic diamide (commercially available as Proseed™), Metalaxyl (methyl N (2,6 dimethylphenyl)-N (methoxyacetyl) d,l-alaninate), Fludioxonil (4 (2,2 difluoro-1,3 benzodioxol-4-yl)-1 H pyrrol-3-carbonitril; commercially available in a blend with mefonoxam as Maxim™ XL), difenoconazole (commercially available as Dividend™ 3FS), carbendazim iprodione (commercially available as Rovral™), ipconazole (commercially available as Rancona from Arysta), mefonoxam (commercially available as Apron™ XL), tebuconazole, carboxin, thiabendazole, azoxystrobin, prochloraz, prothioconazole (commercially available as Redigo from Bayer), sedaxane (commercially available as Vibrance from Syngenta), cymoxanil (1 (2 cyano-2-methoxyiminoacetyl) 3 ethylurea), fludioxonil, a mixture of metalaxyl, cymoxanil and fludioxonil commercially available as Wakil from Syngenta, and oxadixyl (N (2,6 dimethylphenyl)-2-methoxy-N (2 oxo 3 oxazolidinyl) acetamide). A fungicide can be included in the seed coating composition in an amount of 0.0001 to 10% by total weight of the coated seeds.

Typical insecticidal agents include pyrethroids, organophosphates, caramoyloximes, pyrazoles, amidines, halogenated hydrocarbons, neonicotinoids, and carbamates and derivatives thereof. Particularly suitable classes of insecticides include organophosphates, phenylpyrazoles and pyrethoids. Preferred insecticides are those known as terbufos, chlorpyrifos, fipronil, chlorethoxyfos, tefluthrin, carbofuran, imidacloprid, and tebupirimfos. Commercially available insecticides include imidacloprid (commercially available as Gaucho™), and clothianidin (commercially available from BASF as Poncho™), thiametoxam (commercially available from Syngenta as Cruiser™), thiacloprid (commercially available as Sonido from Bayer), Cypermetrin (commercially available from Arysta as Langis™, methiocarb (commercially available as Mesurol from Bayer), fipronil (commercially available from BASF as Regent™), chlorantraniliprole (also known as rynaxypyr, 5-bromo-N-[4-chloro-2-methyl-6 (methylcarbamoyl)phenyl]-2-(3-chloropyridin-2-yl)pyrazole-3 carboxamide, commercially available as Lumivia™ from Corteva) and cyantraniliprole (also known as cyazypyr, 3 bromo-1-(3-chloro-2-pyridyl)-4' cyano-2'-methyl-6' (methylcarbamoyl)pyrazole-5-carboxanilide).

Commercially available nematicidal agents include abamectin (commercially available from Syngenta as Avicta™) thiodicarb (commercially available from Bayer as Aeris™).

Typical molluscicidal agents include metaldehyde (commercially available from Lonza as Meta™) or niclosamid (commercially available from Bayer as Bayluscide™), Cyazypir and Rynaxypir (available from Corteva).

Examples of suitable biologicals include bacilli, Trichoderma, rhizobia (for nitrogen fixation) and the like, which have been identified as seed treatment materials to protect plants and/or enhance their health and/or productive capacity.

These lists are not exhaustive, new active ingredients are continuously developed and can be incorporated in the film and/or seed coating composition.

Nutrients may be present in addition to, or as an alternative to, agrochemical actives. In such formulations the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Nutrients refer to chemical elements and compounds which are desired or necessary to promote or improve plant growth. Suitable nutrients generally are described as macronutrients or micronutrients. Suitable nutrients for use in the concentrates according to the invention are all nutrient compounds.

Micronutrients typically refer to trace metals or trace elements, and are often applied in lower doses. Suitable micronutrients include trace elements selected from zinc, boron, chlorine, copper, iron, molybdenum, and manganese. The micronutrients may be in a soluble form or included as insoluble solids, and may be salts or chelated.

Macronutrients typically refer to those comprising nitrogen, phosphorus, and potassium, and include fertilisers such as ammonium sulphate, and water conditioning agents. Suitable macro nutrients include fertilisers and other nitrogen, phosphorus, potassium, calcium, magnesium, sulphur containing compounds, and water conditioning agents.

Suitable fertilisers include inorganic fertilisers that provide nutrients such as nitrogen, phosphorus, potassium or sulphur. Fertilisers may be included in diluted formulations at relatively low concentrations or as more concentrated solutions, which at very high levels may include solid fertiliser as well as solution.

It is envisaged that inclusion of the nutrient would be dependent upon the specific nutrient, and that micronutrients would typically be included at lower concentrations whilst macronutrients would typically be included at higher concentrations.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The rosin resin is suitably present in the film coating composition at a concentration in the range from 2 wt.% to 30 wt.%, preferably 4 wt.% to 25 wt.%, more preferably 5 wt.% to 22 wt.% based on the total weight of the film coating composition.

In accordance with the invention, the said film coating composition can comprise the starch derivatives in an amount of 1-40 wt.% by total weight of film coating composition, preferably in an amount of 2-30 wt.%, more preferably in an amount of 3-20 wt.%, further preferably 4-15 wt.%.

The wax is suitably present in the film coating composition at a concentration in the range from 0.5 wt.% to 30 wt.%, preferably 1.0 wt.% to 25 wt.%, more preferably 1.5 wt.% to 22 wt.% based on the total weight of the coating composition.

The weight ratio of rosin resin or starch to wax in the film coating composition may be in the is generally from 1.5:1 to 0.5:1, more usually 1.3:1 to 0.7:1 and particularly from 1.1:1 to 0.9:1.

A particular advantage of the present invention may be that the film and resulting seed coating composition may be free or substantially free of microplastic and/or microplastic particles.

The term “microplastic” and “microplastic particles” as used in this application is meant to refer in particular to material consisting of solid polymer-containing particles, to which additives or other substances may have been added, and where more than 1% w/w of particles have dimensions between 1 nm and 5 mm, or for fibres a length of 3 nm to 15 mm and length to diameter ratio of greater than 3. Said polymers would not include those which are naturally occurring and not chemically modified (other than by hydrolysis), and not include polymers that are biodegradable.

Preferably the film and resulting seed coating composition comprises less than 5 wt.% of microplastics and/or microplastic particles, more preferably less than 3 wt.%, further preferably less than 2 wt.%, even further preferably less than 1 wt.%, and particularly less than 0.5 wt.% based on the total weight of the composition. In a particularly preferred embodiment the film and resulting seed coating composition may be free of any microplastic particles.

Coating includes coating techniques as known in the art. It is envisaged that the present invention applies to all said coatings types.

The film coating composition of the present invention can be diluted and formed in to a slurry with other components added in order to make the seed coating composition which is then applied to the seeds or bulbs.

The seed coating composition of the invention may be applied to the seed in conventional manners.

The seed may be primed or not primed (having been subjected to a treatment to improve the germination rate, e.g. osmopriming, hydropriming, matrix priming).

Preferably, the seed coating composition is applied as a liquid composition and/or emulsion and/or dispersion and/or latex composition and thereafter solidified (including cured and/or dried) to form a seed coating. The term “liquid coating composition” as used in this application is meant to include coating compositions in the form of a suspension, emulsion, and/or dispersion, preferably a dispersion.

Conventional means of coating may be employed for coating the seeds. Various coating machines are available to the person skilled in the art. Some well known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater.

Typically, the amount of seed coating composition applied to the seed can be in the range of 0.1 to 200 g dry wt. per kg seed, preferably 0.15 to 150 g dry wt. per kg seed, more preferably 0.25 to 100 g dry wt. per kg seed.

The seed coating composition can, for instance, be applied by film coating, spraying, dipping, or brushing of the seed coating composition. Optionally, it is applied at a temperature of 25° C. to 50° C., for instance 5° C. to 35° C., more often 15° C. to 30° C., for instance at room temperature, such as 18° C. to 25° C. Preferably, the seed coating composition is applied to the seed by film coating. The film coating may suitably be applied by spraying the liquid coating composition onto the seed, typically while the seeds fall or flow through a coating apparatus. Preferably, the method comprises film coating of the seed to apply the seed coating composition in the form of a film coating composition.

Preferably, the method comprises applying the seed coating composition to form an film or seed coating layer.

The seed coating composition is suitably applied to the seed such that the ratio of the dried coating layer to seed is suitably in the range from 0.001 to 20:1, preferably 0.05 to 10:1, more preferably 0.01 to 1.0:1, particularly 0.05 to 0.5:1, and especially 0.1 to 0.2:1 by weight.

Seed coating typically involves forming on the surface of the seeds a firmly adhering, moisture permeable coating. The process typically comprises applying a liquid seed coating composition to the seeds before planting.

An additional film coat layer may optionally be applied over the top of the coating, layer of the invention to provide additional benefits, including but not limited to cosmetics, coverage, actives, nutrients, and processing improvements such as faster drying, seed flow, durability and the like.

The coating provides good dust off and abrasion resistance thereby reducing dust produced during movement of the seeds and allowing lower amounts of active to be incorporated due to decreased coating loss.

The seed coating composition provides for coatings which are more uniform across a seed, and good film forming properties and no need for an added film-former. The coating is also found to be tough and flexible coating with good adhesion.

Coatings also provide good wet and dry flow to coated seeds. The result of this is the seeds can be bagged and sold to be used later or used straight away, and seeds are not wet as this would result in seeds stick together during storage.

The coatings formed of the present invention also provide for a desired viscosity which allows for ease of handling and application to any seeds to be coated.

The coatings also provide good dust off and abrasion resistance thereby reducing dust produced during movement of the seeds and allowing lower amounts of active to be incorporated due to decreased coating loss.

The coating provides good colour retention thereby reducing pigment loss during coating and processing of the seeds.

All of the features described herein may be combined with any of the above aspects, in any combination.

### EXAMPLES

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

### Rosin Based Formulations

Film coat formulations A to C were prepared according to Tables 1 and 2, on the basis of the commercial film coat formulation Disco AG Red L-350 from which binders and wax additives were removed. A PPP (plant protection product) cocktail was used consisting of 10.5 wt.% fungicide (Maxim Quattro™ from Syngenta) and 89.5 wt.% insecticide (Cruiser™ 350 FS from Syngenta). Corn seeds with a TSW (Thousand Seed Weight) of 420 g were coated with a slurry of 42.5 wt.% PPP cocktail, 17.7 wt.% film coat formulations and 39.8 wt.% water; the application rate being 10.3 g/kg seeds, such that 1.83 g film coat formulation per kg seed was applied. A reference sample was prepared by coating corn seeds with the same slurry based on the commercial film coat formulation Disco AG Red L-350 applied at the same dosage of 1.83 g film coat per kg seed.

Table 1

Composition of film coat formulations A to C

| Material | Amount %wt/wt |
|---|---|
| Rosin resin dispersion (see Table 2) | 15.00 |
| Wax additive (see Table 2) | 10.00 |

Table 2

Film coat compositions based on combinations of rosin resin dispersions and wax additives

| | | |
|---|---|---|
| Formulation | Rosin resin dispersion | Wax additive |
| A | Rosin resin dispersion 1 | Wax additive 1 |
| B | Rosin resin dispersion 2 | Wax additive 2 |
| C | Rosin resin dispersion 3 | Wax additive 2 |

### Dust-Off and Abrasion Results

If not carefully treated, seeds coated with actives and other enhancements result in harmful levels of dust during handling and processing of huge quantities of seeds. One of the primary objectives of a film coating is to retain the actives on the seed and reduce dust while in operation.

Dust data for corn seeds treated with film-coats were obtained by following industry standards. 100 grams of seeds were submitted to a 2-minute Heubach test in duplicate, averaging the results to a total amount of dust-off per 100,000 seeds. Abrasion of corn seeds was visually observed after a 10 minute abrasion test run in a PharmaTest PTF20E friability drum rotating at a speed of 25 rpm. The abrasion score is a visual quantification of the quality of seeds after subjecting them to this abrasion test closely simulating handling conditions in the industry.

The abrasion score was allocated from 0 (high abrasion resistance/good quality seeds) to 5 (low abrasion resistance/poor quality seeds). The test is performed on freshly coated seeds to determine the wet abrasion score and on coated seeds after 1 week drying to determine the dry abrasion score.

Table 3 shows the dust (in g / 100,000 seeds) for the different film-coat formulations tested on corn, as well as abrasion scores determined after 10 min abrasion test (0: high abrasion resistance; 5: poor abrasion resistance). These results show that the new compositions enable a good reduction of both dust and abrasion values on corn.

Table 3

Dust-off and abrasion results obtained on coated corn seeds

| | Dust-off (g / 100,000 seeds) | Abrasion score (wet) | Abrasion score (dry) |
|---|---|---|---|
| Raw seeds | 0.46 | | |
| Disco AG Red L-350 | 0.19 | 2.6 | 2.6 |
| Film coat A | 0.23 | 1.5 | 1.5 |
| Film coat B | 0.21 | 0.9 | 1.1 |
| Film coat C | 0.14 | 0.7 | 1.1 |

### Wet and Dry Flowability

The flow of treated/coated seeds is important at the seed treating facility as well as at the farm whilst going through the planter. The lower the friction between the seeds, the better is the efficiency at various stages. Typically, the addition of PPPs and traditional film-coats to seeds slows down the flow of seeds considerably, which is not a desired characteristic. It can be improved by incorporating a flow agent or a slip agent into the film coat formulation. A flow agent is typically a wax-based additive that lowers friction and improves the appearance of the seed.

For the testing the flow of treated seeds, 1 kg of seeds are placed in a funnel fitted with a stopper of 40 mm diameter. The stopper is opened and timer started simultaneously. Wet and dry flow of seeds were measured based on the time it took for the totality of seeds to flow through the funnel, by taking an average of 10 measurements performed directly after coating for the wet flow and an average of 5 measurements performed on the seeds 24h after coating for the dry flow.

The flowability, expressed in g/s is calculated by the following formula: flow (in g/s) = seed weight (in g) / average time (s). When seeds got blocked in the funnel, the equipment was hit with a hammer and the average number of blockages was calculated for both wet and dry flow measurements. The results are shown in Table 4 and illustrate the flow properties of the coated seeds according to the invention.

Table 4

Wet and dry flowability results obtained on coated corn seeds

| | wet flow (g/s) | blockages (wet) | dry flow (g/s) | blockages (dry) |
|---|---|---|---|---|
| Raw seeds | | | 266.2 | 0.0 |
| Disco AG Red L-350 | 124.6 | 1.7 | 192.3 | 0.2 |
| Film coat A | 107.7 | 1.6 | 137.6 | 1.4 |
| Film coat B | 105.3 | 3.0 | 157.0 | 0.8 |
| Film coat C | 112.4 | 1.9 | 166.0 | 0.2 |

### Plantability

The plantability of seeds was measured with a Meter Max Ultra unit, employing a corn disk, a speed of 8 km/h and a 18 inch vacuum. The singulation (expressed in %) corresponds to the percentage of seeds correctly planted at regular spacing. Skip events correspond to the number of times a planting spot has been missed (per 1,000 seeds) and multiple events to the number of times several seeds are planted at a same spot (per 1,000 seeds). The results compiled in Table 5 demonstrate the good planting properties of new film coat compositions against the commercial product Disco AG Red L-350.

Table 5

Results of plantability tests performed on coated corn seeds

| | Singulation (%) | Skips (per 1000 seeds) | Multiples (per 1000 seeds) |
|---|---|---|---|
| Raw seeds | 99.9 | 1.0 | 0.3 |
| Disco AG Red L-350 | 99.5 | 4.7 | 0.3 |
| Film coat A | 99.4 | 5.3 | 0.7 |
| Film coat B | 99.3 | 5.7 | 1.3 |
| Film coat C | 99.1 | 8.0 | 0.7 |

### Starch Based Formulations

Film coat formulations D to F were prepared according to Tables 6 and 7, on the basis of the commercial film coat formulation Disco AG Blue L-570 from which binders and wax additives were removed. A PPP cocktail was used consisting of 38.2 wt.% fungicide Apron XL™ (from Syngenta) and 61.8 wt.% fungicide Maxim XL™ (from Syngenta). Sunflower seeds with a TSW of 62.5 g were coated with a slurry of 37.4 wt.% PPP cocktail, 40.4 wt.% film coat formulations and 22.2 wt.% water; the application rate being 22.5 g/kg seeds, such that 9.10 g film coat formulation per kg seed was applied. A reference sample was prepared by coating sunflower seeds with the same slurry based on the commercial film coat formulation Disco AG Blue L-570 applied at the same dosage of 9.10 g film coat per kg seed.

Table 6

Composition of film coat formulations D to F

| Material | Amount %wt/wt |
|---|---|
| Starch derivative (see Table 7) | 10.00 |
| Wax additive (see Table 7) | 8.00 |

Table 7

Film coat compositions based on combinations of starch derivatives and wax additives

| | | |
|---|---|---|
| Formulations | Starch derivative | Wax additive |
| D | Starch derivative 1 | Wax additive 1 |
| E | Starch derivative 2 | Wax additive 2 |
| F | Starch derivative 3 | Wax additive 2 |

### Dust-Off and Abrasion Results

Dust data for sunflower seeds treated with film-coats were obtained by following industry standards. 100 grams of seeds were submitted to a 2-minute Heubach test in duplicate, averaging the results to a total amount of dust-off per 75,000 seeds. Results displayed in Table 8 demonstrate the excellent dust control of new film coat.

Table 8

Dust-off results obtained on coated sunflower seeds

| | Dust-off (g / 75,000 seeds) |
|---|---|
| Raw seeds | 0.032 |
| Disco AG Blue L-570 | 0.012 |
| Film coat D | 0.001 |
| Film coat E | 0.005 |
| Film coat F | 0.012 |

### Wet and Dry Flowability

A similar protocol was followed to measure the wet and dry flow properties of coated sunflower seeds as described in Example 1, except for the amount of seeds used in the test which was decreased to 500 g. The diameter of the stopper was also changed to 35 mm. The results shown in Table 9 illustrate the excellent flow properties of the seeds coated according to the invention.

Table 9

Wet and dry flowability results obtained on coated sunflower seeds

| | wet flow (g/s) | blockages (wet) | dry flow (g/s) | blockages (dry) |
|---|---|---|---|---|
| Raw seeds | | | 117.8 | 0.0 |
| Disco AG Blue L-570 | 57.3 | 0.5 | 79.5 | 0.0 |
| Film coat D | 57.4 | 1.1 | 80.2 | 0.0 |
| Film coat E | 55.2 | 0.4 | 79.5 | 0.0 |
| Film coat F | 65.6 | 0.2 | 80.5 | 0.0 |

### Plantability

The plantability of sunflower seeds was measured with the same method as previously described, employing a sunflower disk, a speed of 8 km/h and a 12 inch vacuum. Table 10 containing the results of these tests show that the plantability properties of sunflowers seeds coated with the new film coat compositions come in the same range as for the commercial product Disco AG Blue L-570.

Table 10

Results of plantability tests performed on coated sunflower seeds

| | Singulation (%) | Skips (per 1000 seeds) | Multiples (per 1000 seeds) |
|---|---|---|---|
| Raw seeds | 98.8 | 3.5 | 9.0 |
| Disco AG Blue L-570 | 95.6 | 22.5 | 22.0 |
| Film coat D | 93.2 | 44.0 | 24.5 |
| Film coat E | 95.3 | 22.9 | 24.1 |
| Film coat F | 94.3 | 34.8 | 22.6 |

### Spinach Seed Coatings

Film coat formulations B, C and D described in the previous examples were applied on spinach seeds. Spinach seeds with a TSW of 10.4 g were coated with a slurry of 5.6 wt.% fungicide Maxim™ 480FS (from Syngenta), 70.8 wt.% film coat formulations and 23.6 wt.% water; the application rate being 21.2 g/kg seeds, such that 15.0 g film coat formulation per kg seed was applied. A reference sample was prepared by coating spinach seeds with the same slurry based on the commercial film coat formulation Disco Advanced Red L-773 applied at the same dosage of 15.0 g film coat per kg seed. An extra sample of seeds coated with the PPP slurry containing no film coat formulation was used as a reference for germination tests.

### Germination Results

Germination tests were performed on coated spinach seeds according to ISTA germination test standards. Results displayed in Table 11 confirm that the new coating compositions displayed no negative effect on the seed germination when compared to raw seeds and the reference treatment without film coat.

Table 11

Germination results obtained on coated spinach seeds

| | Good plants | Abnormal | Non germinated |
|---|---|---|---|
| Raw seeds | 90 | 5 | 5 |
| PPPs alone | 92 | 5 | 3 |
| Disco Advanced Red L-773 | 89 | 7 | 4 |
| Film coat B | 91 | 7 | 2 |
| Film coat C | 93 | 5 | 2 |
| Film coat D | 91 | 5 | 4 |

### Rice Seed Coatings

Film coat formulations B and C described in the previous examples were applied on rice seeds. Rice seeds with a TSW of 35.1 g were coated with a slurry of 27.7 wt.% insecticide Cruiser™ 350FS (from Syngenta), 32.3 wt.% film coat formulations and 40.0 wt.% water; the application rate being 13.0 g/kg seeds, such that 4.20 g film coat formulation per kg seed was applied. A reference sample was prepared by coating rice seeds with the same slurry based on the commercial film coat formulation Disco AG Red L-529 applied at the same dosage of 4.20 g film coat per kg seed.

### Colour Retention Results

Rice seeds are usually soaked for a period of 24 to 48 hours at the farm prior to sowing. During this soaking step, active ingredients and/or colorants present on the seed may release into the water if no film coat or suboptimal film coats have been applied during the seed treatment step. One of the key selling points of Disco AG Red L-529 is the good retention of active ingredients and colour onto rice seeds during soaking.

Much better colour retention was observed after 48 hours soaking between rice seeds coated with Disco AG Red L-529 and the film coat formulations B and C. The film coating formulations B and C allow for better colour retention on rice seeds.

It is to be understood that the invention is not to be limited to the details of the above embodiments, which are described by way of example only. Many variations are possible.

1. A film coating composition comprising
i) a rosin resin and/or starch derivative; and
ii) a wax dispersion;
wherein the sum amount of the rosin resin and/or starch derivative and the wax dispersion is in a range from 2 wt.% to 60 wt.% based on the total weight of the composition.

2. The composition according to claim 1, wherein the rosin resin has a Ring and Ball softening point from 10° C. to 150° C., and a molecular weight from 300 to 10,000 g/mol.

3. The composition according to claim 1, wherein the composition is a resin dispersion comprising 20 to 80% rosin resin.

4. The composition according to claim 1, wherein the rosin is a glycerol, pentaerythritol or triethylene glycol ester of a rosin acid.

5. The composition according to claim 1, wherein the starch derivative is from corn, pea, potato, sweet potato, banana, barley, wheat, rice, sago, amaranth, tapioca, arrowroot, canna, sorghum, and waxy or high amylose varieties thereof.

6. The composition according to claim 1, wherein the wax dispersion may be selected from the group consisting of natural waxes, or mineral or synthetic wax when bio-degradable or non-polymeric.

7. The composition according to claim 6, wherein the wax dispersion is selected from the group consisting of carnauba wax, bees wax, sunflower wax, soy oil wax, rice bran wax, lanolin wax, sugar cane wax, palm wax, or other vegetable waxes, poly(3-hydroxybutyrate-co-3-hydroxyvalerate) (PHBV) wax, calcium stearate, or polylactic acid (PLA) wax.

8. The composition according to claim 1, wherein the rosin resin is present in the composition at a concentration in a range from 2 wt.% to 30 wt.% based on the total weight of the composition.

9. The composition according to claim 1, wherein the composition comprises the starch derivative in an amount of 1-40 wt.% by total weight of the composition.

10. The composition according to claim 1, wherein the wax dispersion is present in the composition at a concentration in a range from 0.5 wt.% to 30 wt.% based on the total weight of the composition.

11. The composition according to claim 1, wherein the composition comprises less than 5 wt.% of microplastics and/or microplastic particles based on the total weight of the composition.

12. A method of forming a film coating composition which comprises combining
i) a rosin resin and/or starch derivative; and
ii) a wax dispersion;
wherein the sum amount of the rosin resin and/or starch derivative and the wax dispersion is in a range from 2 wt.% to 60 wt.% based on the total weight of the composition.

13. A seed or bulb having a seed coating, the seed coating composition comprising a film coating composition in accordance with claim 1.

14. The seed or bulb according to claim 13, wherein the seed is a plant seed selected from crop seeds selected from the group consisting of corn, sunflower, soybean, cotton, rice, and spinach.

15. A method of coating seeds or bulbs which comprises applying a seed coating composition, the seed coating composition comprising a film coating composition in accordance with claim 1, to the seed or bulb.

16. The method according to claim 15, wherein the amount of water in the seed coating composition is less than 85% by weight based on the total weight of the composition.

17. The method according to claim, wherein the seed composition comprises less than 5 wt.% of microplastics and/or microplastic particles based on the total weight of the composition.

18. The method according to claim 15, wherein the seed coating composition comprises one or more biologically active ingredients.
